(19) United States
(12) Patent Application Publication
(10) Pub. No.: US 2002/0134865 A1
(43) Pub. Date: Sep. 26, 2002

(54) Nozzle-needle stroke adjustment for injectors of fuel injection assemblies

(76) Inventors: Holger Rapp, Hemmingen (DE); Uwe Grytz, Schwieberdingen (DE); Thomas Sommer, Bamberg (DE); Klaus Beier, Frensdorf (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/019,021

(22) PCT Filed: Apr. 23, 2001
(86) PCT No.: PCT/DE01/01539

(30) Foreign Application Priority Data
Apr. 25, 2000 (DE) 100 20 166.0

(51) Int. Cl. F02M 59/00; F02M 61/00

(52) U.S. Cl. 239/533.2

(57) ABSTRACT

The invention relates to an injector (1) for injecting fuel, which is at high pressure, into the combustion chamber of an internal combustion engine, having a valve piston (4) that executes an axial reciprocating motion that generates an actuation of the nozzle needle (19). Between the valve piston (4) and the nozzle needle (19), a pressure piece (17) is provided, which is embodied spherically and is surrounded by an adjusting shim (7).

### FIELD OF THE INVENTION

The invention relates a nozzle needle stroke adjustment in injectors of injection systems of the kind used in fuel injection systems with a high-pressure collection chamber (common rail). For precise metering of the quantity of fuel, which is under very high pressure, required for combustion in the combustion chamber of an internal combustion engine, precise nozzle needle stroke lengths must be preset and adhered to during operation of the injection system.

1 Prior Art

In previous embodiments of injectors for highpressure injection systems for Diesel engines, nozzle needle stroke adjustments are employed in which the needle stroke of the nozzle needle in the injector body is adjusted by means of a cylindrically embodied pressure piece. The pressure piece, embodied with a widened head region, rests with one end face on a face end of a valve piston of the injector; the other face end of the cylindrical pressure piece rests on the top side of the nozzle needle of the injector, and the pressure piece can be surrounded by a guide sleeve.

To adapt the injector with a cylindrical pressure piece to existing conditions of use, which require different nozzle needle stroke lengths and their presetting, and to compensate for tolerances in the length of individual parts, the pressure pieces used until now have been produced in size groups. The size groups are subdivided into three-micrometer gradations and are very expensive to manufacture and size, since only the tiniest tolerances are allowed, which not inconsiderably increases the effort and expense for measurement.

Along with an expensive production of the pressure pieces in size groups, using them requires complicated manipulation. After their production, the pressure pieces have to be washed and classified by size groups before they are sorted into individual batches. This means additional processing steps, which can be only partly automated and require expensive measurement equipment.

Finally, wear can occur between the cylindrical pressure piece and the guide bore surrounding, resulting in increasing play between the pressure piece and the guide sleeve surrounding it.

The increased friction occurring because of the wear then has an adverse effect on the dynamic performance of the injector.

### SUMMARY OF THE INVENTION

With the solution to this problem proposed by the invention of providing a spherical pressure piece between the valve piston and the nozzle needle end face, the expensive production of a cylindrical pressure piece can be avoided in a simple way. The pressure piece proposed according to the invention is no longer subject to any wear, since it no longer has any direct contact with the bore wall surrounding it. Wear caused by friction and the resultant frictional forces on the pressure piece are thus maximally precluded.

The spherical embodiment of the pressure piece makes an exact central introduction of the valve piston force into the nozzle needle possible. The line of action of the compressive force on the top side, opposite the valve piston, of the nozzle needle extends coaxially to the axis of symmetry of the nozzle needle. By the use of a conically shaped receptacle for the pressure piece in the nozzle needle, it is possible to trigger the nozzle needle in the injector nozzle part without transverse force. The introduction, accomplished without transverse force, of the force into the nozzle needle prevents the nozzle needle from becoming tilted in its guide bore, thus substantially lengthening the service life of the injector body designed according to the invention.

If a DIN ball, produced to standards, is used as the pressure piece, then the production costs for the injector can be lowered considerably by using such a pressure piece. The spherical pressure pieces used in the form of DIN balls not only make it possible to lower the cost per piece but also to lower storage costs considerably, with the overall result of less expensive production of the injector proposed according to the invention.

Processing operations such as the classification of conventionally fabricated cylindrical pressure pieces can thus be avoided completely. The spherical pressure pieces can also be used in diameter gradations in the micrometer range, thus providing for simple individual adaptation of the pressure piece used to a given specific intended use.

### DRAWING

The invention will be described in further detail below in conjunction with the drawing.

Shown are:

FIG. 1, an injector embodied in two parts, with a cylindrical pressure piece between the valve piston and the nozzle needle end face; and

FIG. 2, an injector body with a spherical pressure piece provided between the valve piston end face and the nozzle needle surface.

### VARIANT EMBODIMENTS

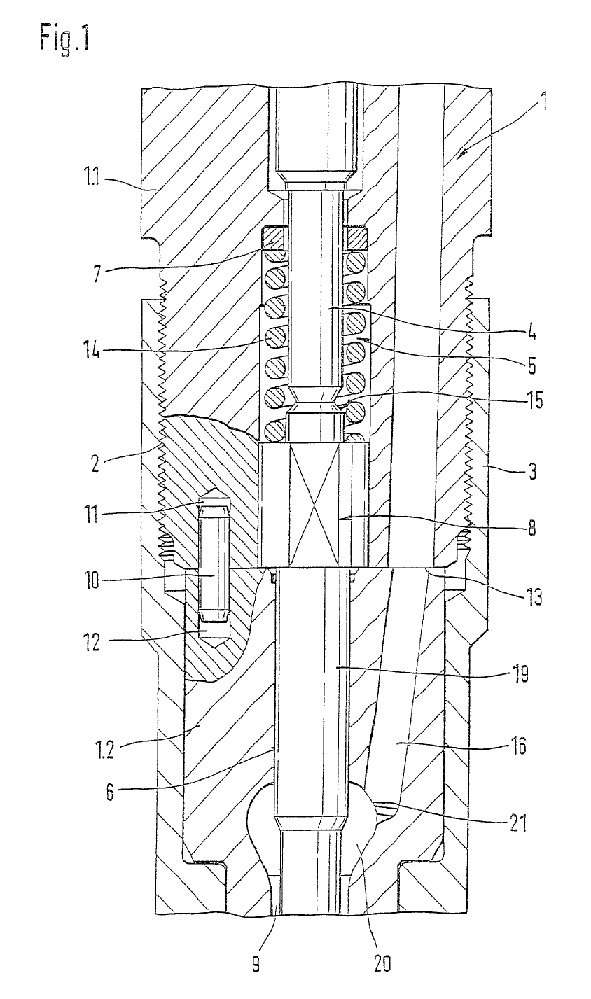

The view in FIG. 1 shows an injector with a cylindrical pressure piece, which is disposed between the valve piston end face and the nozzle needle end face. The injector 1, manufactured from a material that permanently withstands severe mechanical stresses, comprises components connected to one another, that is, the injector body 1.1 and the nozzle body 1.2, which are screwed together by means of a nozzle lock nut 3. A valve piston 4 that executes axial reciprocating motions is received in a bore 5 in the injector body 1.1 and extends coaxially to the axis of symmetry of the injector body 1.1. A bore 6 is made in the nozzle body 1.2, and a nozzle needle 19 is received axially movably in this bore. At a dividing line 13 between the injector body 1.1 and the nozzle body 1.2, the two bore portions in the upper part 1.1 and in the nozzle needle part 1.2 of an inlet bore 16 for the fuel, which is at high pressure and is arriving from the common rail, communicate with one another.

A precise-fit connection between the injector body 1.1 and the nozzle body 1.2 is created by two centering pins 10, of which one is shown in section in FIG. 1.

On one end, each centering pin 10 engages a centering bore 11, which is made in the injector body 1.1. The other end of this centering pin 10, which spans the dividing line 13, is surrounded by a centering bore 12, which is made in the nozzle body 1.2. In the variant embodiment shown, an adjusting shim 7 is let into the bore 5 in the upper part 1.1 of the injector body 1, surrounding the valve piston 4, and a compression spring 14 received by the bore 5 in the upper part 1.1 of the injector body 1 rests on this adjusting shim.

The other end of the compression spring 14 rests on a shoulder of the cylindrical pressure piece 8. In the configuration of FIG. 1, the cylindrical pressure piece 8 is manufactured as a boltlike element, whose narrowed head region is surrounded by several windings of the compression spring 14. At a chamfered end face 15 of the valve piston, the valve piston 4 and the head of the cylindrically shaped pressure piece 8 come into contact with one another. Relative motions between the shaft of the cylindrical pressure piece 8 and the inside of the bore 5 in the injector body 1.1 cause frictional wear between these two components.

The cylindrical pressure piece 8 rests on the top side of the nozzle needle 19, which is surrounded by the bore 6 in the nozzle body 1.2. The bore 6 in the nozzle needle part discharges into a chamber 20, from which a nozzle needle bore 9 extends, ending at the nozzle needle seat, not shown here. The portion of the inlet bore 16 for the fuel that is at high pressure is shown discharging into the chamber 20 and is located in the nozzle needle part 1.2 that is received in the socket 3 of the injector body 1.

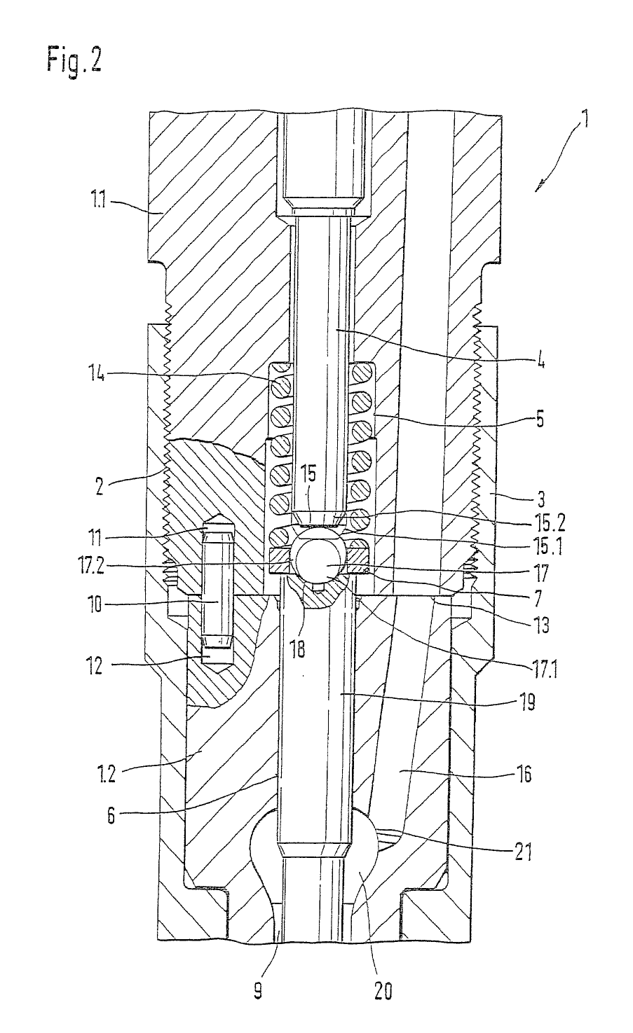

FIG. 2 shows an injector with a spherical pressure piece disposed between the nozzle needle surface and face end of the valve piston.

The injector 1 in the view of FIG. 2 again comprises an injector body 1.1, which is separably connected to a nozzle lock nut 3 at a screw fastening 2; the nozzle lock nut 3 receives a nozzle body 1.2. In comparison with what is shown in FIG. 1, the valve piston 4 of FIG. 2 is embodied with a greater axial length. Located on the underside of the valve piston 4 is an end face 15, which in the configuration of FIG. 2 is shown in both a first tolerance position 15.1 and a second tolerance position 15.2. The valve piston 4 of FIG. 2, extending through a bore 5 in the upper part 1.1 of the injector 1, is surrounded by a compression spring 14 with multiple windings that is braced on one end on the injector body 1.1 and on the other end rests on an adjusting shim 7 that surrounds a spherical pressure piece 17. The adjusting shim 7 in turn rests on the end face of the nozzle needle 19, on which a bearing face 18 can be embodied for fixation of the spherical pressure piece 17. The bearing face 18 can be produced for instance by conical or spherical grinding out of the face end of the nozzle needle 19. The central positioning of the spherically embodied pressure piece 17 on the bearing face 18 of the nozzle needle 19 is accomplished by means of the concentricity to one another of the axes of symmetry of the bearing faces 18 and the nozzle needle 19.

The configuration of FIG. 2, analogously to the view in FIG. 1, shows that the injector body 1.1 as well as the nozzle body 1.2 of the injector body, resting on the injector body at the dividing line 13, are aligned with one another by means of two centering pins 10. Each centering pin 10 is received on one end in a bore 11 of the injector body 1.1 and in a centering bore 12 in the nozzle body 1.2. The bore 6 in the nozzle body 1.2 discharges, analogously to what is shown in FIG. 1, into a chamber 20, from which a nozzle needle bore 9 extends to the nozzle needle seat. By means of the centering pin 10, which centers the dividing line 13 between the injector body 1.1 and the nozzle body 1.2 of the injector 1, the portions of the inlet bore 16 provided in the injector body 1.1 and in the nozzle body 1.2 are likewise aligned with one another for the fuel, which is at high pressure, arriving from the common rail. The inlet bore 16 discharges into the chamber 20, from which the fuel, injected into it at high pressure, flows to the nozzle needle seat.

In the view in FIG. 2, the spherically embodied pressure piece 17 is embodied with two gradations 17.1 and 17.2. At position 15.1, shown in finer lines, of the end face of the valve piston 4, the end face 15 of the valve piston 4 is in central contact with the smaller spherical pressure piece having the size gradation 17.1. The spherically embodied pressure piece 17 with the size gradation 17.1 rests on the bearing face 18, which is embodied on the end face of the nozzle needle 19. The spherical pressure piece of size gradation 17.1 is surrounded by an adjusting shim 7, on which the compression spring 14 that surrounds the valve piston 4 rests.

At position 15.2 of the end face 15 of the valve piston 4, this end face rests on the spherical pressure piece 17 with the size gradation 17.2. In this position as well, the pressure piece 17 having the size gradation 17.2 is completely surrounded by the adjusting shim 7, and it is pressed by the end face 15, put into position, of the valve piston 4 into the bearing face 18 on the top side of the nozzle needle 19.

By means of this configuration, an exactly central introduction of the force of the valve piston 4 into the nozzle needle 19 is possible. This makes triggering of the nozzle needle 19 by the valve piston 4 without transverse force possible, which assures that the nozzle needle 19 will not tilt in its bore 6, which is embodied in the nozzle body 1.2 and merges with the chamber 20. Substantially less wear of the moving components, that is, the pressure piece 17, nozzle needle 9 and nozzle body 1.2, can thus be achieved, and the adjustment of the nozzle spring force, exerted by the compression spring 14, on the end face of the nozzle needle 19 can be varied by means of the thickness of the adjusting shim 7 employed. In comparison to the embodiment known from FIG. 1, only a lengthening of the valve piston 4 and an optimal lengthening of the nozzle needle 19 are required. By means of the diameter classification of the pressure piece 17, a stroke adjustment of the nozzle needle 19, with the stroke stop resting on the upper end of the valve piston, can be accomplished, which is not shown in the drawing.

1. An injector for injecting fuel, which is at high pressure, into the combustion chamber of an internal combustion engine, having a valve piston (4), which executes an axial reciprocating motion that generates an actuation of a nozzle needle (19), a pressure piece (17) being provided between the valve piston (4) and the nozzle needle (19), characterized in that the pressure piece (17) is embodied spherically and is surrounded by an adjusting shim (7).

2. The injector of claim 1, characterized in that a bearing face (18) for the pressure piece (17) is created on the valve piston (4) or on the face end of the nozzle needle (19).

3. The injector of claim 1, characterized in that the pressure piece (17) is disposed replaceably between the valve piston (4) and the nozzle needle (19).

4. The injector of claim 1, characterized in that the pressure piece (17) is embodied in various size gradations (17.1, 17.2).

5. The injector of claim 1, characterized in that the axial stroke of the nozzle needle (19) is adjustable by the size gradation (17.1, 17.2) of the pressure piece (17) used.

6. The injector of claim 1, characterized in that by the centering of the pressure piece (17) in the bearing face (18) of the nozzle needle (19), a transverse-force-free and exact central triggering of the nozzle needle (19) is effected.

7. The injector of claim 1, characterized in that the spring force (14) acting on the nozzle needle (19) is adjustable via the adjusting shim (7) resting on the face end of the nozzle needle (19).
